(19) United States
(12) Patent Application Publication
(10) Pub. No.: US 2025/0005861 A1
(43) Pub. Date: Jan. 2, 2025

(54) ARTISTIC-DRIVEN APPROACH TO LINEWORK GENERATION

(71) Applicants: Sony Group Corporation, Tokyo (JP); Sony Pictures Entertainment Inc., Culver City, CA (US)

(72) Inventors: Pawel Grochola, Culver City, CA (US); Edmond Boulet-Gilly, Vancouver (CA)

(21) Appl. No.: 18/754,552

(22) Filed: Jun. 26, 2024

Related U.S. Application Data
(60) Provisional application No. 63/511,085, filed on Jun. 29, 2023.

(51) Int. Cl. G06T 17/20; G06T 11/20

(52) U.S. Cl. CPC G06T 17/20; G06T 11/203

(57) ABSTRACT

Generating lineworks including: receiving scene data including locations of cameras capturing the scene data; calculating 3-D mesh of the scene data; calculating camera angle relative to the 3-D mesh using the locations of the cameras; parsing the scene data and analyzing potential line locations based on the camera angle relative to the 3-D mesh; generating base curves for the potential line locations; and generating secondary lines on top of the base curves based on a user input to generate stylized curves.

### CROSS-REFERENCE TO RELATED APPLICATIONS

This application claims the benefit of priority under 35 U.S.C. §119(e) of co-pending U.S. Provisional Patent Application No. 63/511,085, filed Jun. 29, 2023, entitled “Artistic driven Approach to Linework Generation”. The disclosure of the above-referenced application is incorporated herein by reference.

### BACKGROUND

### Field

The present disclosure relates to linework generation, and more specifically, to artistic-driven approach to linework generation in animations.

### Background

In the production of movies with worlds rooted in comic book styles, the significance of incorporating linework may become essential. As demand for the linework has grown substantially, lines are applied to both characters and environments in their entirety. Accordingly, a need exists for an efficient way to save linework styles and then batch process the generation of linework efficiently with minimal effort.

### SUMMARY

The present disclosure implements techniques for linework generation.

In one implementation, a method of generating lineworks is disclosed. The method includes: receiving scene data including locations of cameras capturing the scene data; calculating 3-D mesh of the scene data; calculating camera angle relative to the 3-D mesh using the locations of the cameras; parsing the scene data and analyzing potential line locations based on the camera angle relative to the 3-D mesh; generating base curves for the potential line locations; and generating secondary lines on top of the base curves based on a user input to generate stylized curves.

In another implementation, a system for generating lineworks is disclosed. The system includes: a processor to receive scene data and calculate a 3-D mesh, the processor to calculate a camera angle relative to the 3-D mesh using camera locations included in the scene data; an analyzer to parse the scene data and analyze potential line locations based on the camera angle relative to the 3-D mesh; a base curve generator to generate base curves for the potential line locations; and a secondary line generator to generate secondary lines on top of the base curves based on user input to generate stylized curves.

In a further implementation, a non-transitory computer-readable storage medium storing a computer program to generate lineworks is disclosed. The computer program includes executable instructions that cause a computer to: receive scene data including locations of cameras capturing the scene data; calculate 3-D mesh of the scene data; calculate camera angle relative to the 3-D mesh using the locations of the cameras; parse the scene data and analyzing potential line locations based on the camera angle relative to the 3-D mesh; generate base curves for the potential line locations; and generate secondary lines on top of the base curves based on a user input to generate stylized curves.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a flow diagram of a linework generation method in accordance with one implementation of the present disclosure;

FIG. 2A shows one example of an original geometry of the 3-D mesh;

FIG. 2B shows one example of a generated base curve for the potential line locations;

FIG. 2C shows one example of rendered stylized curves;

FIG. 3 shows one example of an interpolation technique to combine the hand-drawn lines with curves generated by the linework generation method;

FIG. 4 illustrates the dual rest redraw approach in accordance with one implementation of the present disclosure;

FIG. 5A illustrates a character partitioned in multiple parts based on screen space angular velocity;

FIG. 5B shows analysis of the activity of each partition;

FIG. 6 is a block diagram of a linework generator in accordance with one implementation of the present disclosure;

FIG. 7A is a representation of a computer system and a user in accordance with an implementation of the present disclosure; and

FIG. 7B is a functional block diagram illustrating the computer system hosting a linework generation application in accordance with an implementation of the present disclosure.

### DETAILED DESCRIPTION

As described above, a need exists for an efficient way to save linework styles and then batch process the generation of linework efficiently with minimal effort.

Certain implementations of the present disclosure provide for artistic-driven approach to linework generation. After reading the below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

Features provided in various implementations for artistic-driven approach to linework generation may include:

(a) high degree of artistic control to fine-tune the appearance of the lines, with each world and character having its unique linework style;

(b) hand-drawn look of the linework which extends beyond the surface for characters with messy appearances;

(c) convincing re-drawing of the linework with dynamic updating rather than remaining static on the geometry;

(d) synchronization of the linework animation with the stepped timing of the character animation;

(e) efficient way to save linework styles and batch process the generation of linework with minimal effort; and

(f) ability to combine hand-made linework with procedurally generated ones.

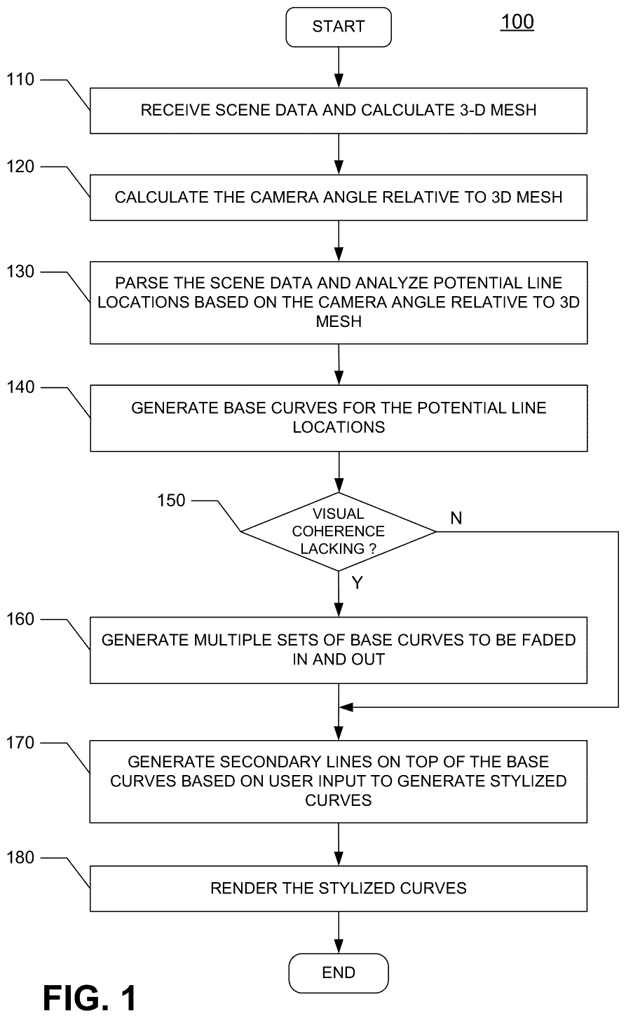

FIG. 1 is a flow diagram of a linework generation method 100 in accordance with one implementation of the present disclosure.

In the illustrated implementation of FIG. 1, scene data is initially received and a 3-D mesh is calculated, at step 110. The scene data also include locations of cameras capturing the scene. A camera angle relative to the 3-D mesh is then calculated, at step 120. The scene data is parsed and potential line locations are analyzed, at step 130, based on the camera angle relative to the 3-D mesh. Base curves for the potential line locations is then generated, at step 140.

In one implementation, a check is made, at step 150, to determine whether a visual coherence of the base curves is lacking. If the visual coherence is lacking, multiple sets of base curves to be faded in and out are generated, at step 160, to ensure the visual coherence from the camera perspective. In one implementation, step 160 in which the sets of base curves to be faded in and out to ensure the visual coherence also involves re-calculating the camera angle relative to the 3-D mesh (step 120).

In one implementation, secondary lines are generated on top of the base curves based on user input, at step 170, to generate stylized curves. In some implementations, the secondary lines being “stylized” means that various properties such as varying tapering and offsetting are assigned to achieve a complex but natural look. The stylized curves are then rendered, at step 180.

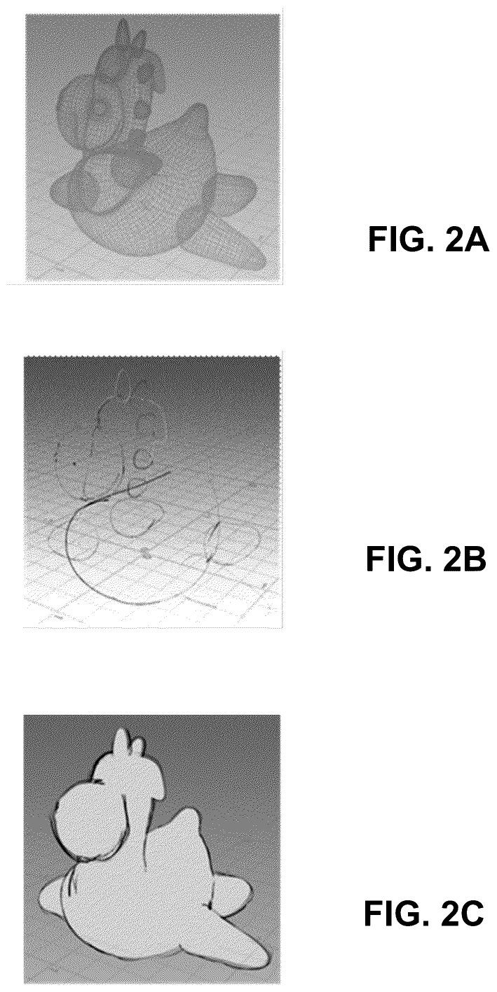

FIGS. 2A through 2C show examples of the original 3-D mesh, the base curves, and the rendered stylized curves.

FIG. 2A shows one example of an original geometry of the 3-D mesh.

FIG. 2B shows one example of a generated base curve for the potential line locations.

FIG. 2C shows one example of rendered stylized curves.

Although the linework generation method of FIG. 1 produced convincing linework, it was determined that combining the method with hand-drawn lines sometimes produced better results. In some implementations, Blender was used to create drawings which were exported to Houdini. In other implementations, vector data were exported from the digital content creation applications. These sets of drawings were then interpolated and merged with the curves generated by the linework generation method.

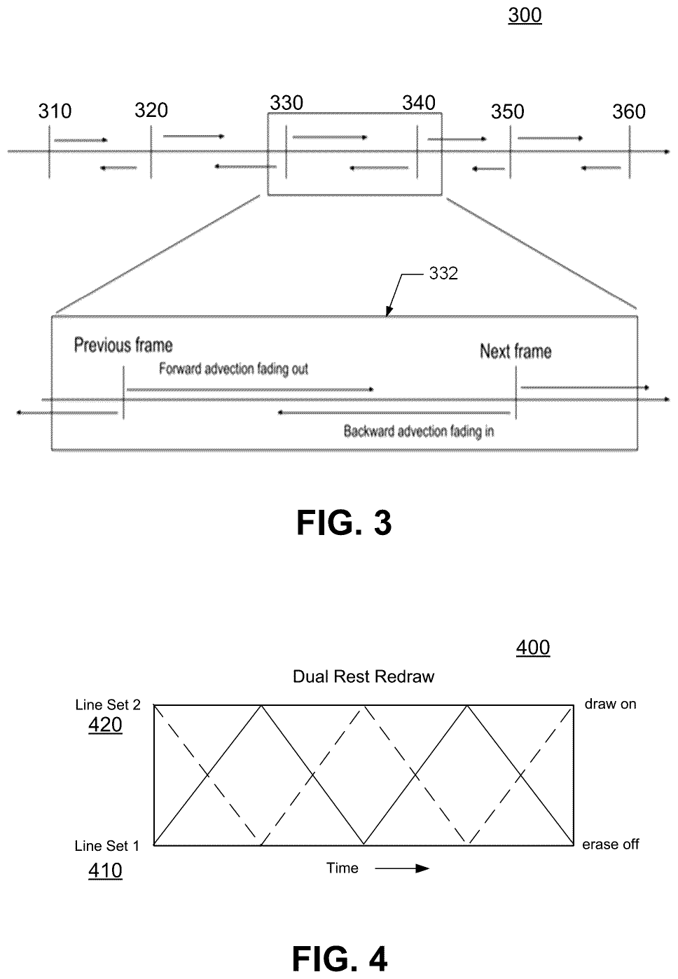

FIG. 3 shows one example of an interpolation technique 300 to combine the hand-drawn lines with curves generated by the linework generation method. In the illustrated implementation of FIG. 3, lines, which are drawn in frames 310, 320, 330, 340, 350, 360, are interpolated and merged between the frames. Expanded view 332 between frames 330 and 340 shows the details of the interpolation and merger process.

Referring to the expanded view 332, lines that are fading out are moving forward in time with the geometry onto which the lines are projected, while the opacity of the line is fading away or the lines are tapering away or both. The expanded view 332 also shows that the lines that are fading in are advected backward in time, starting from the position at which the lines were projected and following the geometry as the lines fade in, again using opacity and tapering to reveal the lines.

In one implementation, combining the generating linework to animation adds further complexities. Thus, in animation, as lines are “drawn on”, the curves gradually reveal opacity like an invisible pencil sketches a line on paper. Likewise, when lines are “erased off”, the curves lose opacity, as if being gradually wiped away. The rate at which this process occurs (i.e., encompassing both the appearance and removal of lines) is known as the “redraw rate.” In some implementations, lines are tapered from one end to the other rather than adjusting the opacity.

In one implementation, determining the optimal “redraw rate” may be difficult. For example, when a character remains relatively stationary or still, a high redraw rate would prove distracting. Conversely, if the redraw rate is set too low for a moving character lines may get stuck on the model. Thus, this raises issues for outlines which may appear disconnected from the silhouette. To address the above-described issues, a “dual rest” approach may be used.

FIG. 4 illustrates the dual rest redraw approach 400 in accordance with one implementation of the present disclosure. In the illustrated implementation of FIG. 4, two sets of lines 410, 420 work in tandem, with one set (e.g., line set 1—solid line) “draw on” while the other set (e.g., line set 2—dashed line) is “erased off” and vice versa. It was determined that having two sets of lines 410, 420 with a correct re-draw rate resulted in a natural looking linework update.

In a further implementation, the dual rest redraw concept was taken to the next level by creating a system that automatically detects the degree of change in a character's performance. This new system establishes appropriate redraw rates across different parts of the character. That is, the system automatically partitions character areas based on screen-space motion, putting body parts that move together in the same partition.

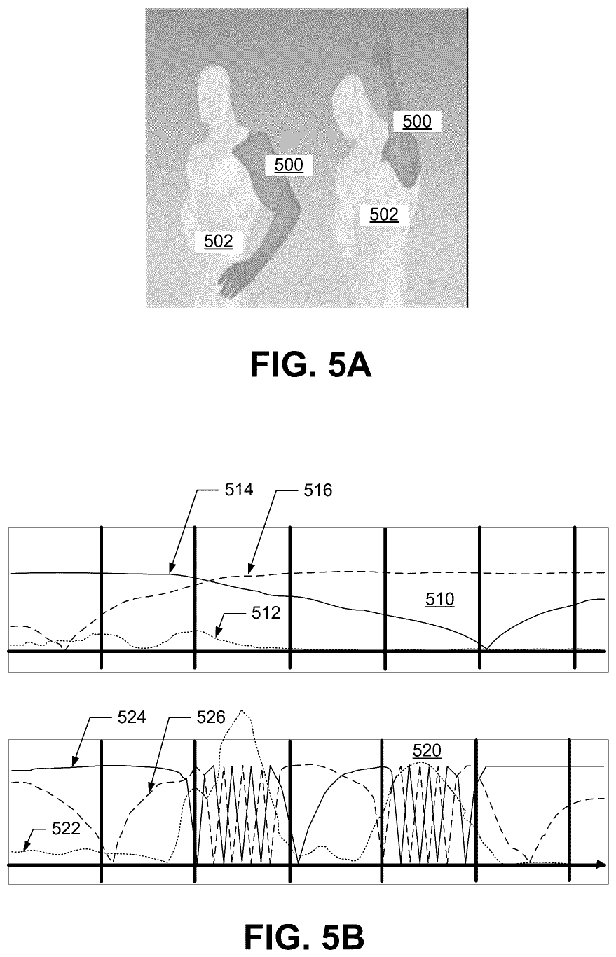

FIGS. 5A and 5B illustrate one example of

partitioning character areas based on screen-space motion in accordance with one implementation of the present disclosure.

FIG. 5A illustrates a character partitioned in multiple parts based on screen space angular velocity.

FIG. 5B shows analysis of the activity of each partition.

In one example shown in FIG. 5A, movement is shown in only the left arm 500 of the character, while little or no movement is shown for the remaining part 502. Thus, the redraw for the part 502 results in a slow moving graph 510 (upper graph in FIG. 5B), while the redraw for the part 500 results in a fast redraw 520 (lower graph in FIG. 5B) during the period when the motion of the left arm is detected. In both graphs of FIG. 5B, the dotted curves 512, 522 quantify the motion speed and solid and dashed curves 514, 516, 524, 526 are set of lineworks drawing on and off (as shown in FIG. 4).

In a further implementation, the approach illustrated in FIGS. 5A and 5B may be extended to groups of objects that move together in screen space such as vehicles on a highway and props in a room.

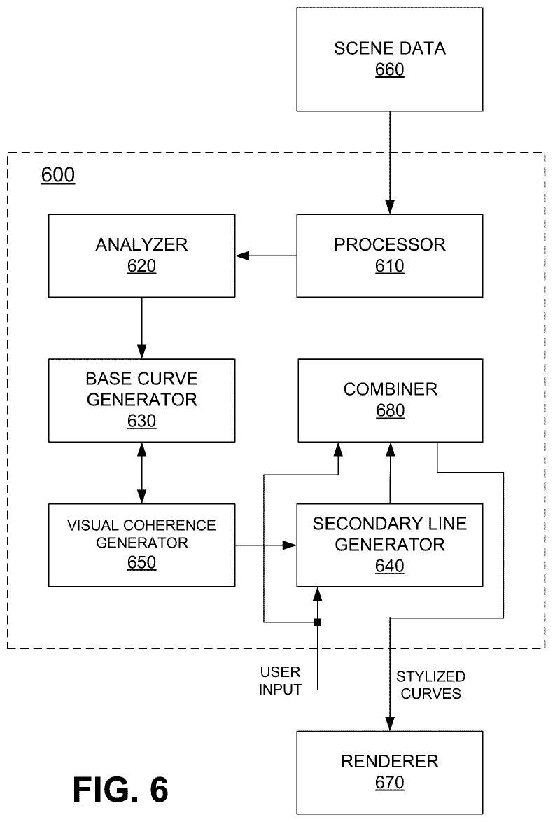

FIG. 6 is a block diagram of a linework generation system 600 in accordance with one implementation of the present disclosure. In the illustrated implementation of FIG. 6, the system 600 includes a processor 610, an analyzer 620, a base curve generator 630, a secondary line generator 640, and a visual coherence generator 650.

In one implementation, the processor 610 receives scene data 660 and calculates a 3-D mesh. The processor 610 also calculates a camera angle relative to the 3-D mesh using camera locations included in the scene data. The analyzer 620 parses the scene data and analyzes potential line locations based on the camera angle relative to the 3-D mesh. The base curve generator 630 generates base curves for the potential line locations.

In one implementation, the visual coherence generator 650 determines whether a visual coherence of the base curve is lacking. If the visual coherence is lacking, the base curve generator 650 then generates multiple sets of base curves to be faded in and out to ensure the visual coherence from the camera perspective. In one implementation, generation of sets of base curves involves re-calculating the camera angle relative to the 3-D mesh.

In one implementation, the secondary line generator 640 generates secondary lines on top of the base curves based on user input to generate stylized curves. In some implementations, the secondary lines being “stylized” means that various properties such as varying tapering and offsetting are assigned to achieve a complex but natural look. The secondary line generator 340 then sends the generated stylized curves to the visual coherence generator 650. In some implementations, the secondary lines are “stylized” which means that various properties such as varying tapering and offsetting are assigned to achieve a complex but natural look.

In one implementation, the linework generation system 600 also includes a combiner 680 which combines the stylized curves with sets of hand-drawn drawings. Further, the combiner 680 may include interpolating and merging the sets of hand-drawn drawings with the curves generated by the linework generation method. The visually coherent stylized curves may be rendered by any generic renderer 670.

In one implementation, steps 110-180 and blocks 610-650 are configured entirely with hardware including one or more digital signal processors (DSPs), general purpose microprocessors, application specific integrated circuits (ASICs), field programmable logic arrays (FPGAs), or other equivalent integrated or discrete logic circuitry. One implementation includes one or more programmable processors and corresponding computer system components to store and execute computer instructions, such as to provide the operation of a wallet infrastructure at the user level and provider level (provider of products, assets, content, etc.).

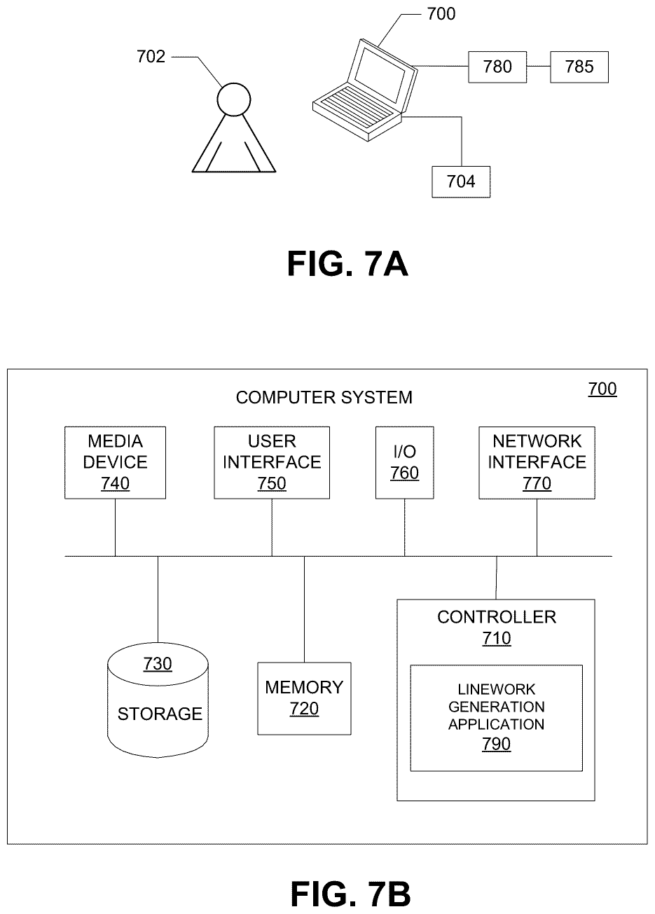

FIG. 7A is a representation of a computer system 700 and a user 702 in accordance with an implementation of the present disclosure. The user 702 uses the computer system 700 to implement an application 790 for linework generation with respect to the process 100 of FIG. 1 and the system 600 of FIG. 6.

The computer system 700 stores and executes the linework generation application 790 of FIG. 7B. In addition, the computer system 700 may be in communication with a software program 704. Software program 704 may include the software code for the linework generation application 790. Software program 704 may be loaded on an external medium such as a CD, DVD, or a storage drive, as will be explained further below.

Furthermore, the computer system 700 may be connected to a network 780. The network 780 may be connected in various different architectures, for example, client-server architecture, a Peer-to-Peer network architecture, or other type of architectures. For example, network 780 may be in communication with a server 785 that coordinates engines and data used within the linework generation application 790. Also, the network may be different types of networks. For example, the network 780 may be the Internet, a Local Area Network or any variations of Local Area Network, a Wide Area Network, a Metropolitan Area Network, an Intranet or Extranet, or a wireless network.

FIG. 7B is a functional block diagram illustrating the computer system 700 hosting the linework generation application 790 in accordance with an implementation of the present disclosure. A controller 710 is a programmable processor and controls the operation of the computer system 700 and its components. The controller 710 loads instructions (e.g., in the form of a computer program) from the memory 720 or an embedded controller memory (not shown) and executes these instructions to control the system, such as to provide the data processing. In its execution, the controller 710 provides the linework generation application 790 with a software system. Alternatively, this service may be implemented as separate hardware components in the controller 710 or the computer system 700.

Memory 720 stores data temporarily for use by the other components of the computer system 700. In one implementation, memory 720 is implemented as RAM. In one implementation, memory 720 also includes long-term or permanent memory, such as flash memory and/or ROM.

Storage 730 stores data either temporarily or for long periods of time for use by the other components of the computer system 700. For example, storage 730 stores data used by the linework generation application 790. In one implementation, storage 730 is a hard disk drive.

The media device 740 receives removable media and reads and/or writes data to the inserted media. In one implementation, for example, the media device 740 is an optical disc drive.

The user interface 750 includes components for accepting user input from the user of the computer system 700 and presenting information to the user 702. In one implementation, the user interface 750 includes a keyboard, a mouse, audio speakers, and a display. In another implementation, the user interface 750 also includes a headset worn by the user and used to collect eye movements as user inputs. The controller 710 uses input from the user 702 to adjust the operation of the computer system 700.

The I/O interface 760 includes one or more I/O ports to connect to corresponding I/O devices, such as external storage or supplemental devices (e.g., a printer or a PDA). In one implementation, the ports of the I/O interface 760 include ports such as: USB ports, PCMCIA ports, serial ports, and/or parallel ports. In another implementation, the I/O interface 760 includes a wireless interface for communication with external devices wirelessly.

The network interface 770 includes a wired and/or wireless network connection, such as an RJ-45 or “Wi-Fi” interface (including, but not limited to 802.11) supporting an Ethernet connection.

The computer system 700 includes additional hardware and software typical of computer systems (e.g., power, cooling, operating system), though these components are not specifically shown in FIG. 7B for simplicity. In other implementations, different configurations of the computer system may be used (e.g., different bus or storage configurations or a multi-processor configuration).

The description herein of the disclosed implementations is provided to enable any person skilled in the art to make or use the present disclosure. Numerous modifications to these implementations would be readily apparent to those skilled in the art, and the principles defined herein can be applied to other implementations without departing from the spirit or scope of the present disclosure. Thus, the present disclosure is not intended to be limited to the implementations shown herein but is to be accorded the widest scope consistent with the principal and novel features disclosed herein. Accordingly, additional variations and implementations are also possible.

In one particular implementation, a method of generating lineworks is disclosed. The method includes: receiving scene data including locations of cameras capturing the scene data; calculating 3-D mesh of the scene data; calculating camera angle relative to the 3-D mesh using the locations of the cameras; parsing the scene data and analyzing potential line locations based on the camera angle relative to the 3-D mesh; generating a base curve for the potential line locations; and generating secondary lines on top of the base curve based on a user input to generate stylized curves.

In one implementation, generating the stylized curves includes assigning properties to achieve a natural look. In one implementation, the properties include varying tapering and offsetting. In one implementation, the method further includes determining whether visual coherence of the base curves is lacking. In one implementation, the method further includes generating and fading in and out multiple sets of base curves when the base curves lack visual coherence. In one implementation, the method further includes rendering the stylized curves. In one implementation, the method further includes adding hand-drawn lines to the stylized curves. In one implementation, adding the hand-drawn lines include exporting vector data from a digital content creation application to produce sets of drawings. In one implementation, the method further includes interpolating and merging the sets of drawings with the stylized curves.

In another particular implementation, a system for generating lineworks is disclosed. The system includes: a processor to receive scene data and calculate a 3-D mesh, the processor to calculate a camera angle relative to the 3-D mesh using camera locations included in the scene data; an analyzer to parse the scene data and analyze potential line locations based on the camera angle relative to the 3-D mesh; a base curve generator to generate base curves for the potential line locations; and a secondary line generator to generate secondary lines on top of the base curves based on user input to generate stylized curves.

In one implementation, the secondary line generator generates the stylized curves by assigning properties to achieve a natural look. In one implementation, the assigned properties include varying tapering and offsetting. In one implementation, the system further includes a visual coherence generator to determine whether visual coherence of the base curves is lacking, wherein the base curve generator generates and fades in and out sets of base curves when the base curves lack visual coherence. In one implementation, the system further includes a combiner to add sets of hand-drawn drawings to the stylized curves. In one implementation, the combiner exports vector data from a digital content creation application to produce sets of drawings. In one implementation, the combiner further interpolates and merges the sets of drawings with the stylized curves.

In yet another particular implementation, a non-transitory computer-readable storage medium storing a computer program to generate lineworks is disclosed. The computer program includes executable instructions that cause a computer to: receive scene data including locations of cameras capturing the scene data; calculate 3-D mesh of the scene data; calculate camera angle relative to the 3-D mesh using the locations of the cameras; parse the scene data and analyzing potential line locations based on the camera angle relative to the 3-D mesh; generate base curves for the potential line locations; and generate secondary lines on top of the base curves based on a user input to generate stylized curves.

In one implementation, the executable instructions that cause the computer to generate the stylized curves includes executable instructions that cause the computer to assign properties including varying tapering and offsetting. In one implementation, the non-transitory computer-readable storage medium further includes executable instructions that cause the computer to generate and fade in and out multiple sets of base curves when the base curves lack visual coherence. In one implementation, the non-transitory computer-readable storage medium further includes executable instructions that cause the computer to: add hand-drawn lines to the stylized curves; export vector data from a digital content creation application to produce sets of drawings; and interpolate and merge the sets of drawings with the stylized curves.

All features of each of the above-discussed examples are not necessarily required in a particular implementation of the present disclosure. Further, it is to be understood that the description and drawings presented herein are representative of the subject matter which is broadly contemplated by the present disclosure. It is further understood that the scope of the present disclosure fully 10 encompasses other implementations that may become obvious to those skilled in the art and that the scope of the present disclosure is accordingly limited by nothing other than the appended claims.

1. A method of generating lineworks, comprising:
receiving scene data including locations of cameras capturing the scene data;
calculating 3-D mesh of the scene data;
calculating camera angle relative to the 3-D mesh using the locations of the cameras;
parsing the scene data and analyzing potential line locations based on the camera angle relative to the 3-D mesh;
generating base curves for the potential line locations; and
generating secondary lines on top of the base curves based on a user input to generate stylized curves.

2. The method of claim 1, wherein generating the stylized curves includes assigning properties to achieve a natural look.

3. The method of claim 2, wherein the properties include varying tapering and offsetting.

4. The method of claim 1, further comprising
determining whether visual coherence of the base curves is lacking.

5. The method of claim 4, further comprising:
generating and fading in and out multiple sets of base curves when the base curves lack visual coherence.

6. The method of claim 1, further comprising
rendering the stylized curves.

7. The method of claim 1, further comprising
adding hand-drawn lines to the stylized curves.

8. The method of claim 7, wherein adding the hand-drawn lines include
exporting vector data from a digital content creation application to produce sets of drawings.

9. The method of claim 8, further comprising
interpolating and merging the sets of drawings with the stylized curves.

10. A system for generating lineworks, comprising:
a processor to receive scene data and calculate a 3-D mesh, the processor to calculate a camera angle relative to the 3-D mesh using camera locations included in the scene data;
an analyzer to parse the scene data and analyze potential line locations based on the camera angle relative to the 3-D mesh;
a base curve generator to generate base curves for the potential line locations; and
a secondary line generator to generate secondary lines on top of the base curves based on user input to generate stylized curves.

11. The system of claim 10, wherein the secondary line generator generates the stylized curves by assigning properties to achieve a natural look.

12. The system of claim 11, wherein the assigned properties include varying tapering and offsetting.

13. The system of claim 10, further comprising
a visual coherence generator to determine whether visual coherence of the base curves is lacking,
wherein the base curve generator generates and fades in and out sets of base curves when the base curves lack visual coherence.

14. The system of claim 10, further comprising
a combiner to add sets of hand-drawn drawings to the stylized curves.

15. The system of claim 14, wherein the combiner exports vector data from a digital content creation application to produce sets of drawings.

16. The system of claim 15, wherein the combiner further interpolates and merges the sets of drawings with the stylized curves.

17. A non-transitory computer-readable storage medium storing a computer program to generate lineworks, the computer program comprising executable instructions that cause a computer to:
receive scene data including locations of cameras capturing the scene data;
calculate 3-D mesh of the scene data;
calculate camera angle relative to the 3-D mesh using the locations of the cameras;
parse the scene data and analyzing potential line locations based on the camera angle relative to the 3-D mesh;
generate base curves for the potential line locations; and
generate secondary lines on top of the base curves based on a user input to generate stylized curves.

18. The non-transitory computer-readable storage medium of claim 17, wherein the executable instructions that cause the computer to generate the stylized curves includes
executable instructions that cause the computer to assign properties including varying tapering and offsetting.

19. The non-transitory computer-readable storage medium of claim 17, further comprising
executable instructions that cause the computer to generate and fade in and out multiple sets of base curves when the base curves lack visual coherence.

20. The non-transitory computer-readable storage medium of claim 17, further comprising executable instructions that cause the computer to:
add hand-drawn lines to the stylized curves;
export vector data from a digital content creation application to produce sets of drawings; and
interpolate and merge the sets of drawings with the stylized curves.
